(19) United States
(12) Patent Application Publication
(10) Pub. No.: US 2018/0204459 A1
(43) Pub. Date: Jul. 19, 2018

(54) CROWD SOURCING FOR IDENTIFYING VEHICLE BEHAVIOR PATTERNS

(71) Applicant: INTERNATIONAL BUSINESS MACHINES CORPORATION, Armonk, NY (US)

(72) Inventors: Lisa M.W. BRADLEY, Cary, NC (US); Liam HARPUR, Dublin (IE); Aaron J. QUIRK, Cary, NC (US); Lin SUN, Cary, NC (US)

(21) Appl. No.: 15/407,866

(22) Filed: Jan. 17, 2017

(51) Int. Cl. G08G 1/16; G08G 1/04; G08G 1/0962; G08G 1/017

(52) U.S. Cl. CPC G08G 1/164; G08G 1/04; G08G 1/0175; G08G 1/166; G08G 1/0962; G08G 1/163

(57) ABSTRACT

A computer-implemented method includes: receiving, by a computer device and from a first plurality of vehicles, reports that describe driving behaviors of a second plurality of vehicles; determining, by the computer device and based on the reports, a pattern of driving behavior of a target vehicle of the second plurality of vehicles; and notifying, by the computer device, a user about the determined pattern of driving behavior of the target vehicle. The computer device that performs the receiving, the determining, and the notifying may be a central repository that is remote from the first plurality of vehicles and the second plurality of vehicles.

### BACKGROUND

The present invention generally relates to vehicle behavior pattern monitoring and, more particularly, to systems and methods that utilize crowd sourcing to identifying behavior patterns of vehicles traveling on the roadway.

Drivers often notice other vehicles on the road making poor or dangerous decisions. However, it is unlikely the same driver will encounter the same poorly driven vehicle on a regular basis or even more than once. Hence, there is not a good way for the driver to know whether a vehicle has a history of poor driving or if an observed behavior is a rare occurrence.

### SUMMARY

In an aspect of the invention, a computer-implemented method includes: receiving, by a computer device and from a first plurality of vehicles, reports that describe driving behaviors of a second plurality of vehicles; determining, by the computer device and based on the reports, a pattern of driving behavior of a target vehicle of the second plurality of vehicles; and notifying, by the computer device, a user about the determined pattern of driving behavior of the target vehicle. The computer device that performs the receiving, the determining, and the notifying may be a central repository that is remote from the first plurality of vehicles and the second plurality of vehicles.

In an aspect of the invention, there is a computer program product that includes a computer readable storage medium having program instructions embodied therewith, the program instructions being executable by a computer device to cause the computer device to: receive reports from a first plurality of vehicles about observed driving behaviors of a second plurality of vehicles, wherein each report includes: a license plate number of a respective one of the second plurality of vehicles; and a categorized description of a driving behavior of the respective one of the second plurality of vehicles; determine, based on the reports, a pattern of driving behavior of a target vehicle of the second plurality of vehicles; and notify a user about the determined pattern of driving behavior of the target vehicle.

In an aspect of the invention, a system includes: a CPU, a computer readable memory and a computer readable storage medium associated with a computer device; program instructions to receive, by the computer device of the first vehicle, user input visually describing a second vehicle; program instructions to determine, by the computer device of the first vehicle, a target vehicle based on the user input; program instructions to obtain, by the computer device of the first vehicle, identification information of the target vehicle; program instructions to receive and categorize, by the computer device of the first vehicle, user input describing an observed driving behavior of the target vehicle; and program instructions to transmit, by the computer device of the first vehicle to a central repository, data comprising the identification information of the target vehicle and a categorized description of the observed driving behavior of the target vehicle. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an exemplary environment in accordance with aspects of the present invention.

FIGS. 5 and 6 show flowcharts of exemplary methods in accordance with aspects of the present invention.

### DETAILED DESCRIPTION

The present invention generally relates to vehicle behavior pattern monitoring and, more particularly, to systems and methods that utilize crowd sourcing to identifying behavior patterns of vehicles traveling on the roadway. Aspects of the invention involve enabling a driver of a first vehicle to use voice commands to identify and describe a driving behavior a nearby second vehicle. In embodiments, an on-board system of the first vehicle receives the voice command and obtains an image of identifying information of the second vehicle, e.g., a license plate number of the second vehicle. The on-board system of the first vehicle converts the description of the driving behavior to metadata and transmits the metadata and the identifying information of the second vehicle to a remote service (e.g., a cloud-based service).

According to aspects of the invention, the service receives metadata and identifying information from plural different reporting vehicles, and aggregates the metadata for each respective identified vehicle (e.g., based on the identifying information) to create a driving behavior profile for the identified vehicle. In this manner, the service creates a behavior profile for an identified vehicle based on crowd sourcing plural different reports received from plural different reporting vehicles that have observed the identified vehicle. The service may forward the behavior profile, or a message based on the behavior profile, to drivers of other vehicles that are determined to be within a predefined range of the identified vehicle. The service may forward the behavior profile, or a message based on the behavior profile, to the driver of the identified vehicle.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

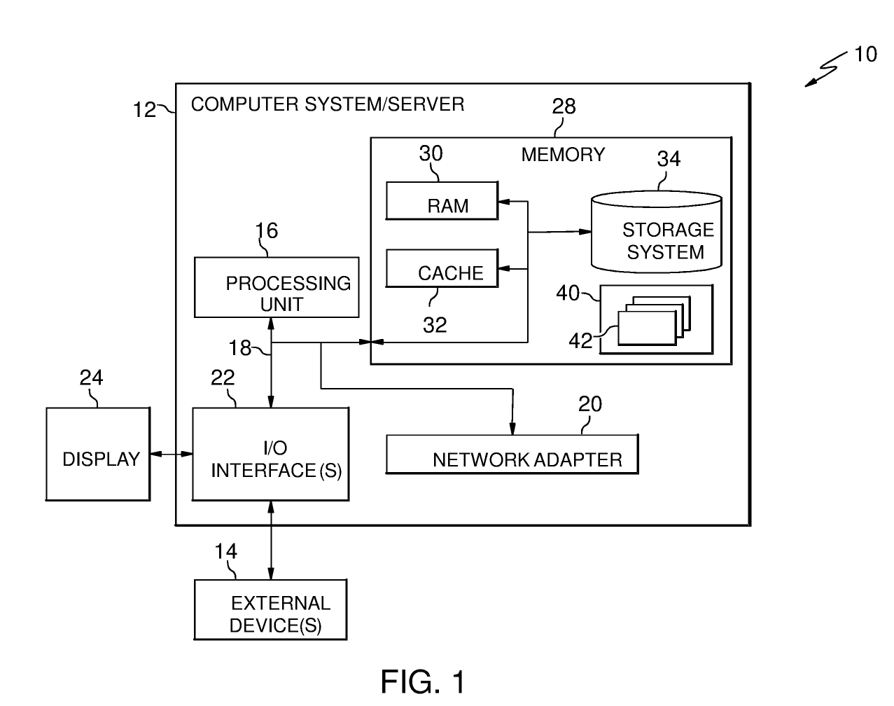

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

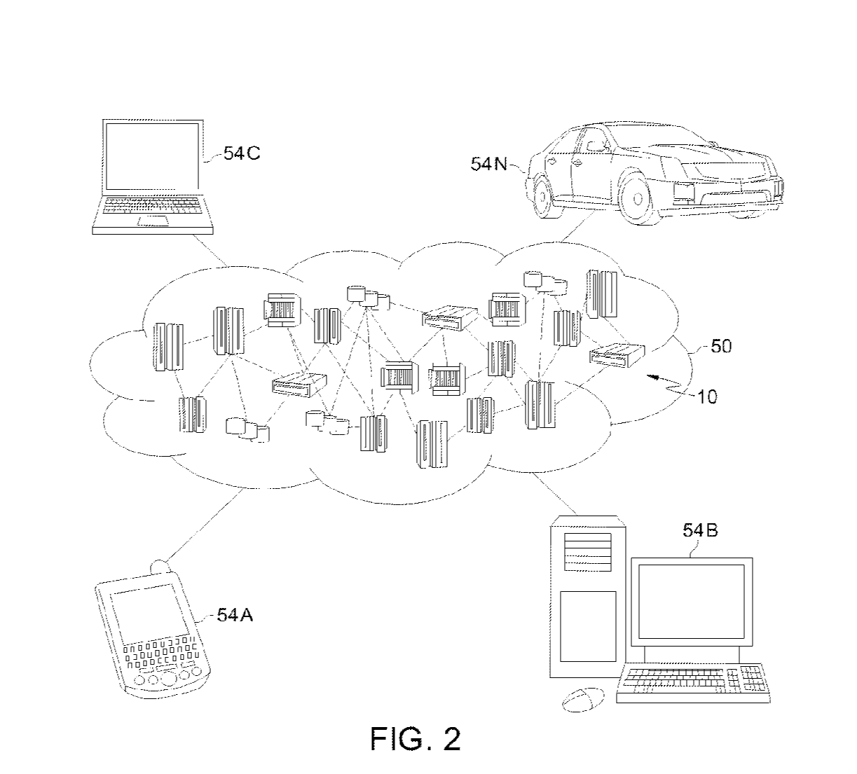

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

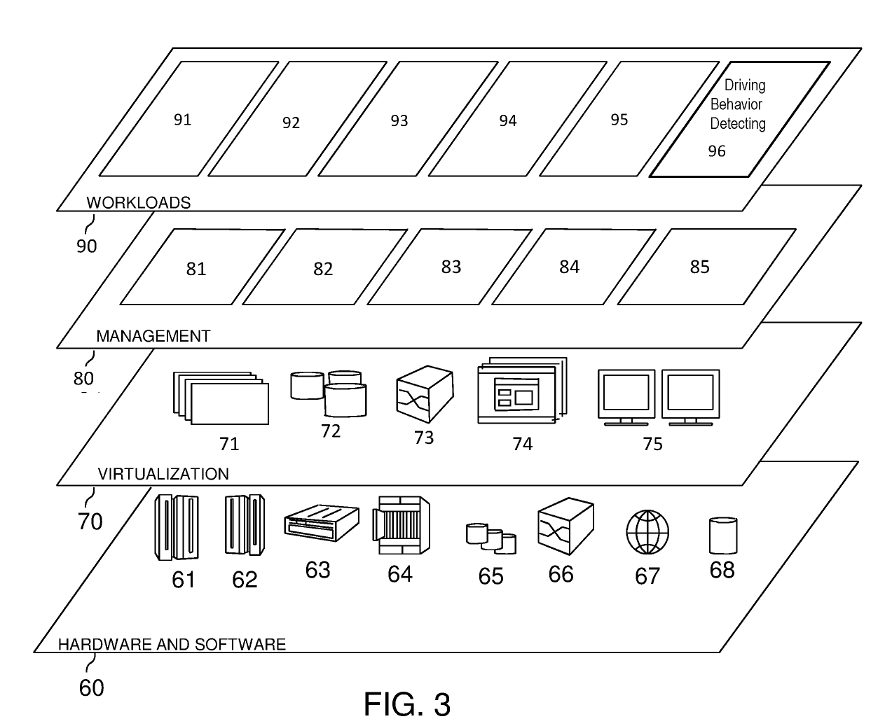

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and driving behavior detecting 96.

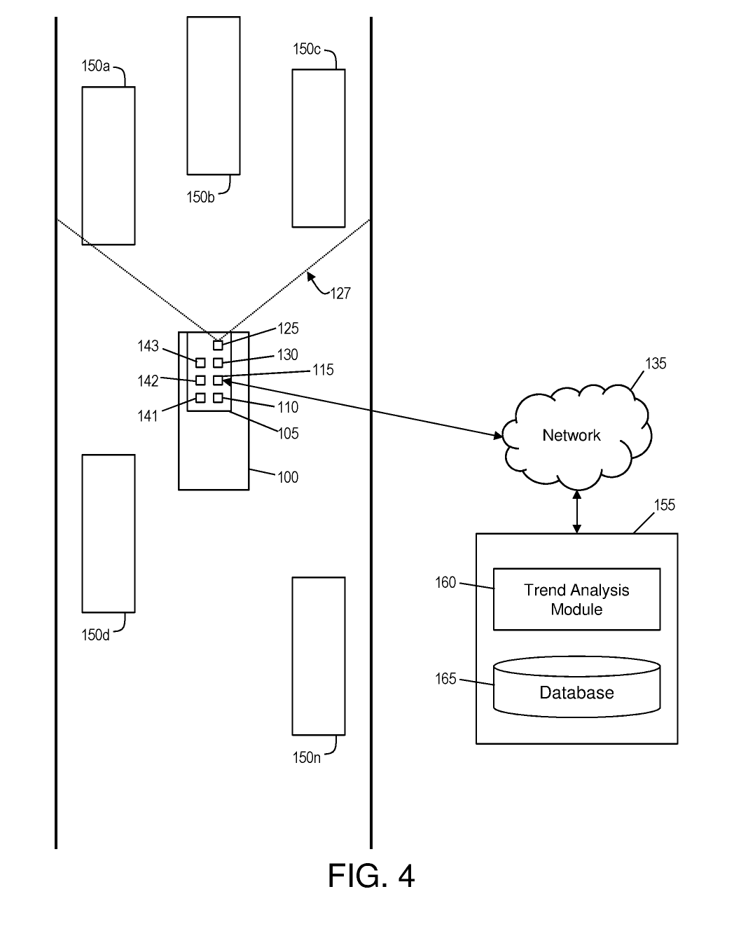

Referring back to FIG. 1, the program/utility 40 may include one or more program modules 42 that generally carry out the functions and/or methodologies of embodiments of the invention as described herein, such as the functionally of driving behavior detecting 96 of FIG. 3. Specifically, the program modules 42 may receive user information, generate a service list based on the user information, and display user information and selected services for service provider personnel. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be implemented in the environment shown in FIG. 4.

FIG. 4 shows an environment in accordance with aspects of the invention. The environment includes a vehicle 100 which may be any suitable motor vehicle including but not limited to a car, truck, or motorcycle. The vehicle 100 includes an on-board computer 105, which may include one or more components of computer system 12 of FIG. 1, such as a processor, a memory, and one or more program modules that perform functions of aspects of the invention. In accordance with aspects of the invention, a display 110, an antenna 115, an imaging system 125, and an audio input 130 are operatively connected to the computer 105 of the vehicle 100. The display 110 may comprise, for example, a touch screen LCD that is configured to display a user interface and receive input from a user (e.g., a driver or passenger in the vehicle 100).

In embodiments, the antenna 115 is configured for radio communication between the vehicle 100 and a network 135 that is external to the vehicle 100. The antenna 115 may comprise a single antenna or plural antennae, and may be configured for any suitable radio communication protocol including but not limited to at least one of Bluetooth, WiFi, and cellular.

In embodiments, the imaging system 125 is configured to capture images of other vehicles 150a-n that are nearby the vehicle 100. The imaging system 125 may comprise at least one camera having a field of view 127 that is configured to capture images of other vehicles nearby the vehicle 100. The imaging system 125 may include plural cameras at different locations on the vehicle 100 to provide fields of view ahead of, behind, and to both sides of the vehicle 100.

In embodiments, the audio input 130 is configured to receive voice commands from a driver or passenger in the vehicle 100. The audio input 130 may comprise, for example, at least one microphone inside the vehicle 100.

Each of the display 110, the antenna 115, the imaging system 125, and the audio input 130 may be integrated with the vehicle 100 or may be a separate device that is connected to the vehicle 100. In an exemplary embodiment, the display 110, the antenna 115, the imaging system 125, and the audio input 130 are integrated with the vehicle 100, e.g., all these components are part of the vehicle 100 and are permanently connected to the computer 105. In another exemplary embodiment, the computer 105 is integrated with the vehicle 100, and the display 110, the antenna 115, the imaging system 125, and the audio input 130 are included in a user computer device, such as a smartphone, that wirelessly communicates with the computer 105, e.g., via Bluetooth pairing. In another exemplary embodiment, the computer 105 is a user computer device, such as a smartphone, and includes the display 110, the antenna 115, the imaging system 125, and the audio input 130.

In embodiments, the computer 105 includes a voice recognition module 141 that converts voice commands received at the audio input 130 to data (e.g., text data) that is used by the computer 105 for processes described herein. The computer 105 may also include an identification module 142 configured to identify a target vehicle, in an image obtained by the imaging system 125, based on a voice command description of the target vehicle. The computer 105 may also include a categorization module 143 that categorizes a description of an observed behavior of a target vehicle. Each of the modules 141-143 may be a program module 42 as described with respect to FIG. 1.

Still referring to FIG. 4, the environment includes a central repository 155. In embodiments, the central repository 155 includes a server (such as computer system/server 12 of FIG. 1) that includes a trend analysis module 160 (e.g., a module 42 as described with respect to FIG. 1) and that includes or has access to a database 165. In embodiments, the central repository 155 receives and stores data describing observed driving behaviors of plural vehicles, and analyzes the data to determine patterns of driving behavior of individual ones of the vehicles. The central repository 155 may also be configured to report the determined pattern of driving behavior of a vehicle to various interested individuals, including: a driver of the vehicle for which the pattern of driving behavior is determined, and drivers of bystander vehicles that are nearby the vehicle for which the pattern of driving behavior is determined. In a cloud implementation of the invention, each of the vehicles 100 and 150a-n, and the central repository 155 may be cloud computing nodes 10 as described with respect to FIG. 2.

Implementations of the invention enable the driver of the vehicle 100 to use voice commands to identify a nearby vehicle (e.g., vehicle 150a) and describe an observed operation of the nearby vehicle. The voice command is received by the audio input 130 of the vehicle 100. Based on the voice command, the imaging system 125 on the vehicle 100 obtains identification information (e.g., a license plate number) of the nearby vehicle. The description of the observed operation of the nearby vehicle is summarized and attached as metadata to data defining the identification information (e.g., a license plate number) of the nearby vehicle, and the data is transmitted using the antenna 115 to a central repository 155 via the network 135. In this manner, implementations of the invention may include: voice tagging of a nearby vehicle; combining vehicle identification with a behavior tag for trend analysis; providing anonymous feedback to the operator of a tagged vehicle with negative trending data; providing anonymous feedback to the operator of a vehicle with positive trending data; and providing alerts to drivers nearby a vehicle with a determined behavioral trend data. This advantageously provides an opportunity to improve safety of drivers with an identified history of poor driving and to increase the safety of other drivers that are nearby vehicles with an identified history of poor driving.

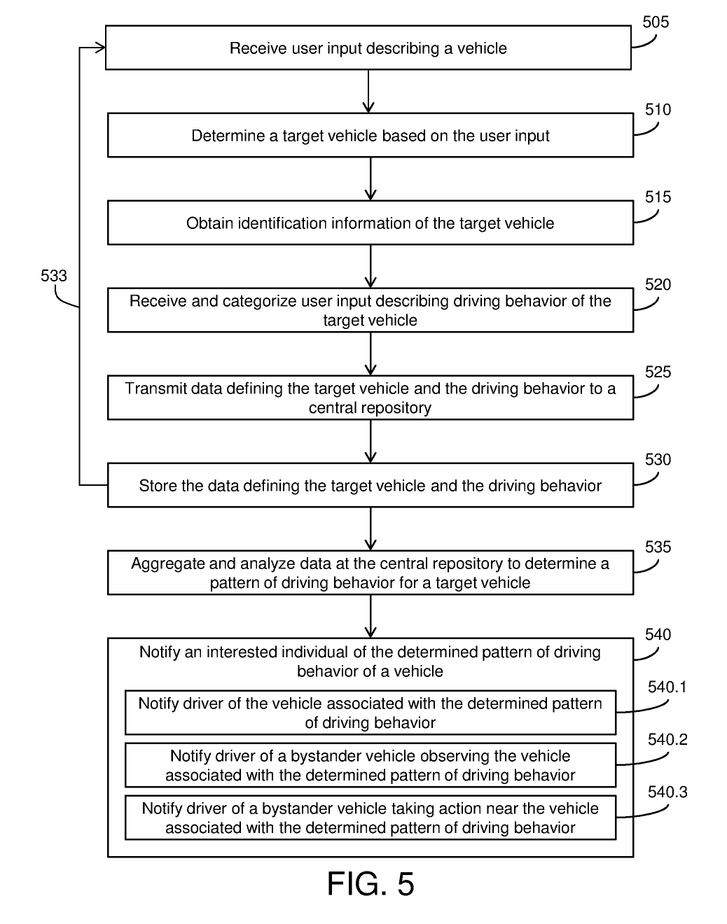

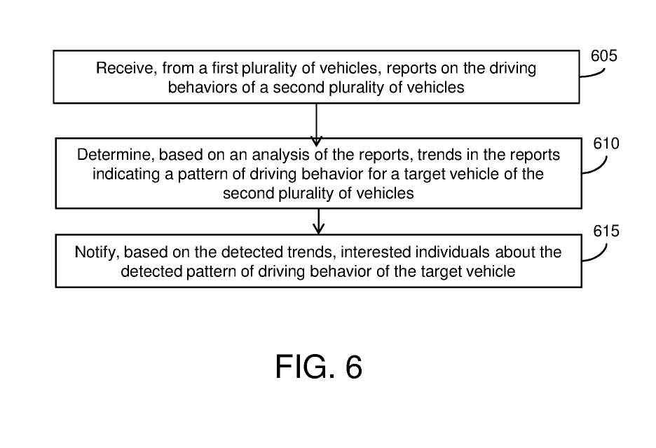

FIGS. 5 and 6 show flowcharts of exemplary methods in accordance with aspects of the present invention. The steps of FIGS. 5 and 6 may be implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

Referring to FIG. 5, at step 505 the system (e.g., computer 105) receives user input that describes a vehicle. In embodiments, step 505 includes the driver of the vehicle 100 using a voice command to describe the second vehicle (e.g. vehicle 150a), and the voice command being received by the audio input 130 and provided to the computer 105. The voice command may include a description of the visual appearance of the second vehicle, such as “blue sedan” or “red tractor trailer”. In embodiments, the recognition module 141 converts the voice command to description data that is used by the computer 105.

At step 510, the system determines a target vehicle based on the user input from step 505. In embodiments, the identification module 142 is configured to leverage the description data from the voice command (from step 505) to identify the described vehicle. In embodiments, the identification module 142 is programmed with image recognition techniques that compare the description data from the voice command to an image of vehicles currently observed by, e.g., in the field of view 127 of, the imaging system 125. In the example shown in FIG. 4, vehicles 150a, 150b, and 150c are in the field of view 127. The identification module 142 is programmed to rank, based on the comparing, all the vehicles currently observed by the imaging system 125 (e.g., vehicles 150a-c in this example), wherein the ranking indicates a relative degree of each respective vehicle matching the description data from the voice command that was received at step 505. For example, a highest ranked vehicle most closely matches the description data and a lowest ranked vehicle least closely matches the description data.

Still referring to step 510, the computer 105 may be configured to prompt the driver of the vehicle 100 to confirm the described vehicle. In embodiments, the computer 105 displays on the display 110 a still image of the highest ranked vehicle and prompts the driver to confirm or reject the displayed vehicle as the described vehicle. For example, after ranking the vehicles in the field of view of the imaging system 125 based on the description data, the computer 105 displays an image of the highest ranked vehicle on the display 110. The image is from the imaging system 125 and may be cropped and/or highlighted in a manner that prominently shows the highest ranked vehicle.

With continued reference to step 510, upon displaying an image of the highest ranked vehicle, the computer 105 may wait for user input to confirm or reject the displayed vehicle as the described vehicle. The user input may be a voice command received by the audio input 130. For example, the user may provide a voice command to reject the displayed vehicle if there is a false positive or a duplicate match (e.g., two white sedans). Based on receiving a user input that rejects the displayed vehicle, the computer 105 displays an image of the next highest ranked vehicle on the display 110 and waits for user input to confirm or reject the now-displayed vehicle as the described vehicle. The computer 105 continues in this manner, displaying an image of a next highest ranked vehicle on the display 110, until the user provides input that confirms a displayed vehicle as the described vehicle. When the user provides input that confirms a displayed vehicle, the computer 105 deems the displayed vehicle as the target vehicle. In this manner, the system provides the user with a hands free method to scroll through images of nearby vehicles until the user confirms via voice command that a displayed image contains the vehicle that the user described with their initial voice command (from step 505).

At step 515, the system obtains identification information of the target vehicle that was determined at step 510. In embodiments, the computer 105 uses the imaging system 125 to obtain the identification information. In a particular embodiment, the identification information is a license plate number of the target vehicle that is captured in an image by the imaging system 125 and determined, from the image, by an image recognition module of the computer 105. A license plate number as used herein may include one or more letters, one or more numbers, or a combination of one or more letters and one or more numbers displayed on the license plate of the target vehicle.

At step 520, the system receives user input that describes a behavior of the target vehicle. In embodiments, step 520 includes the driver of the vehicle 100 using a voice command to describe the behavior of the target vehicle (e.g., the second vehicle 150 as depicted in FIG. 4), with the voice command being received by the audio input 130 and provided to the computer 105. Similar to step 505, the voice recognition module 141 of the computer 105 may convert the voice command to text data (e.g., voice to text) that is used by the computer 105. In embodiments, the computer 105 analyzes the text data to categorize the described behavior into one of a plurality of predefined categories. In this regard, the categorization module 143 may be configured to extract one or more keywords from the text data, compare the extracted keyword(s) to category keywords that are assigned to each of the predefined categories, and determine a category for the text data based on a best match of the extracted keyword(s) to the category keywords. For example, the user may speak “car is swerving and crossing center lane” and the categorization module 143 may categorize this text data in the category “failure to stay in lane.”

Still referring to step 520, any number and type of categories, and associated category keywords, may be programmed into the categorization module 143. Exemplary categories may include at least one of: failure to stay in lane; talking on cell phone; typing on device while driving; speeding; tailgating; aggressive driving; let me in lane during heavy traffic; and allowed pedestrian extra time to cross intersection. Aspects of the invention are not limited to these categories, and other categories may be used. Categories may have a negative inference of unsafe driving behavior (failure to stay in lane; talking on cell phone; typing on device while driving; speeding; tailgating; and aggressive driving), or may have a positive inference of courteous driving behavior (e.g., let me in lane during heavy traffic; and allowed pedestrian extra time to cross intersection).

At step 525, the system transmits data defining the target vehicle and the behavior to a central repository. In embodiments, the computer 105 transmits the data via the network 135 to the central repository 155, e.g., using the antenna 115 for wireless communication in the network 135. In embodiments, the data transmitted at step 525 includes: the identification information (e.g., the license plate number) obtained at step 515; an image (e.g., still photograph) of the target vehicle obtained by the imaging system 125 at step 510; the text of the user input that describes the behavior of the target vehicle (from step 520); and the determined category of the behavior (from step 520). The data may be transmitted in any suitable data structure.

At step 530, the system receives and stores the data defining the target vehicle and the behavior. In embodiments, the central repository 155 receives and stores the data (from step 525) in the database 165 in a manner that associates the data defining the behavior with the identification information of the target vehicle. A date and time that the data was received may also be stored with each entry.

As indicated by arrow 533, the steps 505, 510, 515, 520, 525, and 530 may be performed multiple times to populate the database 165 of the central repository 155. For example, the single vehicle 100 may perform the steps at different times for plural different target vehicles. In another example, plural different vehicles (e.g., vehicle 100 and other vehicles) may perform the steps for a same target vehicle. And in yet another example, plural different vehicles may perform the steps for plural different target vehicles. In this manner, the central repository 155 uses crowd souring to collect and store reports for plural different target vehicles, where there may be more than one report for each respective target vehicle. In embodiments, the central repository 155 stores the data in the database 165 in a manner that permits aggregating plural reports for any one of the target vehicles, e.g., using the identification information such as the license plate number of each target vehicle. In this manner, when a particular target vehicle is the subject of plural different reports, the central repository 155 may use the identification information of the particular target vehicle to aggregate the data from the plural reports for analysis of driving behavior trends of the particular target vehicle.

At step 535, the system analyzes data stored at the central repository to determine a pattern of driving behavior for a target vehicle. In embodiments, the central repository 155 includes a trend analysis module 160 that is programmed to, for each stored identification information (i.e., license plate number), aggregate data from plural reports stored in association with that identification information, and analyze the aggregated data to determine a pattern of driving behavior for the target vehicle associated with the identification information.

In one example, the analysis may include determining that a certain category of behavior (e.g., talking on cell phone while driving) has been reported more than a threshold number of times. For example, the central repository 155 may include plural reports received and stored for a license plate number. Each of the plural reports may include one or more categories of observed behavior (e.g., failure to stay in lane; talking on cell phone; typing on device while driving; speeding; tailgating; aggressive driving; let me in lane during heavy traffic; and allowed pedestrian extra time to cross intersection). In embodiments, the trend analysis module 160 may aggregate the data from the plural reports and determine an aggregate number of instances of each category. The trend analysis module 160 may compare the determined aggregate number of instances of each category to a predefined threshold value. When the determined aggregate number of instances of a category exceeds the threshold value, then the trend analysis module 160 may determine that the target vehicle has a driving behavior associate with that category. For example, if the threshold value is three, and the target vehicle has five reports of ‘talking on cell phone while driving’, then the trend analysis module 160 determines that the target vehicle has a pattern of driving behavior of ‘talking on cell phone while driving’.

In embodiments, a time window may be used with the thresholds in identifying a pattern of driving behavior of a target vehicle. For example, using the date and time associated with each report (from step 530), the trend analysis module 160 determines a number of instances of each category of behavior within a predefined time window. The time window may be a user defined value, such as for example within the past month. In this scenario, the trend analysis module 160 determines that the target vehicle has a pattern of driving behavior when the determined aggregate number of instances of a category exceeds the threshold value within the time window.

Still referring to the trend analysis of step 535, plural thresholds may be used to determine a severity of the detected driving behavior. For example, a first threshold value may be indicative of a low level severity, a second threshold value may be indicative of a medium level severity, and a third threshold value may be indicative of a high level of severity. For example, the first, second, and third threshold values may be defined as three, six, and nine, respectively. A target vehicle having an aggregate number of instances of ‘tailgating’ greater than or equal to the first threshold (e.g., three) and less than the second threshold (e.g., six) is identified as low severity tailgating. A target vehicle having an aggregate number of instances of ‘tailgating’ greater than or equal to the second threshold (e.g., six) and less than the third threshold (e.g., nine) is identified as medium severity tailgating. A target vehicle having an aggregate number of instances of ‘tailgating’ greater than or equal to the third threshold (e.g., nine) is identified as high severity tailgating. Aspects of the invention are not limited to this particular example, and any number of different thresholds having any appropriate values may be used.

At step 540, the system notifies an interested individual of a pattern of driving behavior that was determined for a vehicle at step 535. In embodiments, the central repository 155 transmits data, via the network 135, to an on-board computer of a receiving vehicle (e.g., similar to computer 105). The data may include the determined pattern of driving behavior and an identification of the vehicle that is associated with (i.e., the subject of) the determined pattern of driving behavior. The receiving vehicle may be the vehicle that is associated with the determined pattern of driving behavior, or may be a different vehicle referred to herein as a bystander vehicle. Step 540 may include transmitting the data in one of three exemplary notification steps 540.1, 540.2, and 540.3.

At step 540.1, the central repository 155 notifies the driver of the vehicle associated with the determined pattern of driving behavior. The notification can include a description of the determined pattern of driving behavior, and an indication that the pattern of driving behavior has been determined based on observation of other drivers. In the event that the determined pattern of driving behavior has a negative inference (e.g., failure to stay in lane; talking on cell phone; typing on device while driving; speeding; tailgating; or aggressive driving), the receiving driver may use the notification to adjust their driving style to avoid performing the unsafe driving behavior. In the event that the determined pattern of driving behavior has a positive inference (e.g., let me in lane during heavy traffic; or allowed pedestrian extra time to cross intersection), the receiving driver may use the notification to continue this type of courteous driving behavior.

Still referring to step 540.1, in accordance with aspects of the invention, the system permits a user to opt-in to receiving notifications such as those described with respect to step 540.1, i.e., a notification of the user's own determined driving behavior. For example, a user may register their vehicle (e.g., license plate number) with the central repository 155 and provide contact information (such as an email address, text messaging number, physical mailing address, etc.) for receiving the notification. A parent may use this aspect to receive notifications of determined patterns of driving behavior for a vehicle that is driven by their child.

At step 540.2, the central repository 155 notifies the driver of a bystander vehicle observing the vehicle associated with the determined pattern of driving behavior. In this embodiment, the bystander vehicle uses its imaging system (e.g., imaging system 125) to obtain images of license plate numbers of other vehicles that are in the field of view of the imaging system. The system determines, using the license plate numbers and the data stored in the database 165, whether there are any determined patterns of driving behavior associated with any of the observed license plate numbers. In the event there is a determined pattern of driving behavior associated with one the observed license plate numbers, the system notifies the driver of the bystander vehicle. The notification can include one or more of: a description of the vehicle associated with the determined pattern of driving behavior (e.g., blue sedan); a description of the license plate number of the vehicle associated with the determined pattern of driving behavior; and a description of the determined pattern of driving behavior (e.g., tailgating, etc.).

Still referring to step 540.2, in accordance with aspects of the invention, the user receiving the notification can set user preferences for how the notification is delivered. For example, the user may opt to have the notification delivered as an audible message via a speaker of the bystander vehicle or a speaker of a user-computer device. In another example, the user may opt to have the notification delivered as a visual message, e.g., on a display (e.g., display 110) of the bystander vehicle.

At step 540.3, the central repository 155 notifies the driver of a bystander vehicle taking action near the vehicle associated with the determined pattern of driving behavior. In this embodiment, the on-board computer (e.g., computer 105) of the bystander vehicle determines that the driver of the bystander vehicle has activated a turn signal of the bystander vehicle (e.g., the right turn signal). Based on determining the activation of the turn signal, the imaging system (e.g., imaging system 125) of the bystander vehicle obtains images of license plate numbers of other vehicles that are in the direction of the activated turn signal, e.g., to the right and rear of the vehicle in this example. Using the observed license plate numbers, the system determines whether there are any determined patterns of driving behavior for vehicles that are in the direction of the activated turn signal (e.g., in a manner similar to that described with respect to step 540.2). In the event there is a determined pattern of driving behavior associated with one the observed license plate numbers in the direction of the activated turn signal, the system notifies the driver of the bystander vehicle. The notification can include one or more of: a description of the vehicle associated with the determined pattern of driving behavior (e.g., blue sedan); a description of the license plate number of the vehicle associated with the determined pattern of driving behavior; and a description of the determined pattern of driving behavior. For example, the notification may include the message ‘white pickup truck, license plate XYZ usually lets cars into their lane’. Similar to step 540.2, the notification may be delivered as an audible message, a visual message, or both.

In both steps 540.2 and 540.3, the on-board computer of the bystander vehicle may communicate in real time with the central repository to obtain the determined pattern of driving behavior for a vehicle nearby the bystander vehicle. For example, the bystander vehicle may transmit the license plate number of one or more nearby vehicles to the central repository 155, and the central repository 155 may transmit a determined pattern of driving behavior associated with one of the license plate numbers back to the bystander vehicle.

Referring to FIG. 6, at step 605 the system (e.g., central repository 155) receives, from a first plurality of vehicles, reports on the driving behaviors of a second plurality of vehicles. Step 605 may be performed in a manner similar to step 530 based on plural different vehicles (e.g., the first plurality of vehicles) performing steps 505, 510, 515, 520, 525 to report driving behaviors of plural target vehicles (e.g., the second plurality of vehicles).

At step 610, the central repository 155 determines, based on an analysis of the reports, trends in the reports indicating a pattern of driving behavior for a target vehicle of the second plurality of vehicles. Step 610 may be performed in a manner similar to step 535. For example, the trend analysis module 160 may aggregate and analyze the data in the database 165 to determine a pattern of driving behavior for a particular vehicle referred to as the target vehicle in this example.

At step 615 the central repository 155 notifies, based on the detected trends, interested individuals about the detected pattern of driving behavior of the target vehicle. Step 615 may be performed in a manner similar to step 540.

In the method, a driver of the target vehicle may subscribe to notifications from the central repository and accordingly be among the interested individuals that receive the notification of the detected pattern.

The method may include: receiving, by a vehicle and from the central repository, notification of the detected pattern of driving behavior of the target vehicle; detecting, by the notified vehicle, the target vehicle as being nearby the notified vehicle; and alerting, by the notified vehicle and in response to the detecting, a driver of the notified vehicle that the target vehicle is nearby and that the target vehicle has the detected pattern of driving.

The method may include: receiving, by an onboard vehicle computer of a vehicle and from the central repository, notification of the detected pattern of driving behavior of the target vehicle; identifying, by the onboard vehicle computer, that a driver of the notified vehicle has activated a turn signal of the notified vehicle to indicate that the driver intends to change vehicle lanes to a new lane; searching, using an imaging system of the notified vehicle and in response to the turn signal activation, for the identity of vehicles in the new lane; determining, based on the searching, that the target vehicle is currently in the new lane; and alerting, based on the determining, the driver of the notified vehicle that the target vehicle is in the new lane and that the target vehicle has the detected pattern of driving.

The method may include generating and sending the reports to the central repository according to the following steps: receiving, by a voice recognition system on a first vehicle, an initial voice command from a driver of the first vehicle identifying a target vehicle nearby (e.g., “blue car on the left”); detecting, based on the initial voice command and using an imaging system on the first vehicle, the target vehicle; providing the driver with an image of the target vehicle taken by the imaging system; receiving, by the voice recognition system, a response from the driver positively identifying that the vehicle shown in the image is the target vehicle; capturing, in response to the positive identification, an image of the license plate of the target vehicle; prompting the driver to provide a description of the driving behavior of the target vehicle; receiving the behavior description from the driver; categorizing the driver behavior based on the behavior description; and providing the driver behavior category and the license plate number in the report to the central repository.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer device and from a first plurality of vehicles, reports that describe driving behaviors of a second plurality of vehicles;
determining, by the computer device and based on the reports, a pattern of driving behavior of a target vehicle of the second plurality of vehicles; and
notifying, by the computer device, a user about the determined pattern of driving behavior of the target vehicle,
wherein the computer device that performs the receiving, the determining, and the notifying is a central repository that is remote from the first plurality of vehicles and the second plurality of vehicles.

2. The method of claim 1, wherein the notified user is a driver associated with the target vehicle that has subscribed to notifications from the central repository.

3. The method of claim 1, wherein the notified user is a driver of a bystander vehicle that is different from the target vehicle.

4. The method of claim 3, wherein the notifying comprises transmitting data from the central repository to the bystander vehicle, the data including: a visual description of the target vehicle; a license plate number of the target vehicle; and a description of the determined pattern of driving behavior.

5. The method of claim 3, wherein the notifying is performed based on receiving a license plate number of the target vehicle from the bystander vehicle.

6. The method of claim 1, wherein each report includes:
a license plate number of a respective one of the second plurality of vehicles;
a photo of the respective one of the second plurality of vehicles;
an original text description of a driving behavior of the respective one of the second plurality of vehicles; and
a categorized description of the driving behavior of the respective one of the second plurality of vehicles.

7. The method of claim 1, wherein the determining comprises: aggregating plural ones of the reports associated with the target vehicle, and comparing an aggregated number of instances of a category of driving behavior to a threshold value.

8. The method of claim 7, wherein the aggregated number of instances of the category of driving behavior are aggregated over a predefined time window.

9. The method of claim 1, wherein the central repository comprises a node in a cloud environment and performs the notifying as a service in the cloud environment.

10. A computer program product comprising a computer readable storage medium having program instructions embodied therewith, the program instructions executable by a user device to cause the computer device to:
receive reports from a first plurality of vehicles about observed driving behaviors of a second plurality of vehicles, wherein each report includes: a license plate number of a respective one of the second plurality of vehicles; and a categorized description of a driving behavior of the respective one of the second plurality of vehicles;
determine, based on the reports, a pattern of driving behavior of a target vehicle of the second plurality of vehicles; and
notify a user about the determined pattern of driving behavior of the target vehicle.

11. The computer program product of claim 10, wherein the notified user is a driver associated with the target vehicle that has subscribed to notifications from a central repository.

12. The computer program product of claim 10, wherein the notified user is a driver of a bystander vehicle that is different from the target vehicle.

13. The computer program product of claim 12, wherein the notifying comprises transmitting data from a central repository to the bystander vehicle, the data including: a visual description of the target vehicle; a license plate number of the target vehicle; and a description of the determined pattern of driving behavior.

14. The computer program product of claim 12, wherein the notifying is performed based on receiving a license plate number of the target vehicle from the bystander vehicle.

15. A system, comprising:
a CPU, a computer readable memory, and a computer readable storage medium associated with a computer device of a first vehicle;
program instructions to receive, by the computer device of the first vehicle, user input visually describing a second vehicle;
program instructions to determine, by the computer device of the first vehicle, a target vehicle based on the user input;
program instructions to obtain, by the computer device of the first vehicle, identification information of the target vehicle;
program instructions to receive and categorize, by the computer device of the first vehicle, user input describing an observed driving behavior of the target vehicle; and
program instructions to transmit, by the computer device of the first vehicle to a central repository, data comprising the identification information of the target vehicle and a categorized description of the observed driving behavior of the target vehicle,
wherein the program instructions are stored on the computer readable storage medium for execution by the CPU via the computer readable memory.

16. The system of claim 15, wherein the determining the target vehicle based on the user input comprises:
displaying an image of a respective one of plural vehicles to the user; and
prompting the user for input to confirm or reject the respective one of plural vehicles as the target vehicle.

17. The system of claim 16, further comprising:
obtaining the image of the respective one of plural vehicles using an imaging system on the first vehicle; and
repeating the displaying and the prompting until the user confirms one of plural vehicles as the target vehicle.

18. The system of claim 15, further comprising:
obtaining, by the computer device of the first vehicle, a license plate number of another vehicle within a field of view of an imaging system of the first vehicle;
transmitting the license plate number to the central repository;
receiving, from the central repository, a determined pattern of driving behavior of the other vehicle; and
notifying the user of the determined pattern of driving behavior of the other vehicle.

19. The system of claim 18, wherein the notifying comprises providing, by the computer device of the first vehicle, an audible description of the other vehicle and the determined pattern of driving behavior of the other vehicle.

20. The system of claim 18, wherein:
the obtaining is based on determining that a turn signal of the first vehicle is activated; and
the field of view of the imaging system of the first vehicle is on a side of the first vehicle corresponding to the turn signal.
